(19) United States
(12) Patent Application Publication
(10) Pub. No.: US 2024/0370267 A1
(43) Pub. Date: Nov. 7, 2024

(54) RUNTIME CONFIGURABLE MODULAR PROCESSING TILE

(71) Applicant: Arm Limited, Cambridage (GB)

(72) Inventors: Nicholas John Cook, Kenilworth (GB); Remy Pottier, Grenoble (FR); Vasileios Laganakos, Saffron Walden (GB); Diya Soubra, Nice (FR)

(73) Assignee: Arm Limited, Cambridge (GB)

(21) Appl. No.: 18/430,952

(22) Filed: Feb. 2, 2024

(30) Foreign Application Priority Data
May 5, 2023 (EP) 23386033.7

(51) Int. Cl. G06F 9/38

(52) U.S. Cl. CPC G06F 9/3818

(57) ABSTRACT

The present disclosure relates to a data processing system comprising: at least one modular processing tile comprising runtime-configurable processing circuitry; and a control module to control the at least one modular processing tile, said control module comprising: instruction decoding circuitry to decode instructions; information collecting circuitry to collect information relating to said at least one modular processing tile; and instruction processing circuitry to process instructions decoded by the instruction decoding circuitry, wherein, in response to an instruction to perform a processing task, said instruction processing circuitry generates configuration instruction based on the collected information relating to said at least one modular processing tile, and said runtime-configurable processing circuitry is configured at runtime to perform said processing task in response to said configuration instruction. In some embodiments, plural modular processing tiles may be aggregated and configured at runtime to perform a dedicated function similar to a cortical column in the human brain.

### FIELD OF THE INVENTION

The present technology relates to data processing.

### BACKGROUND

Conventionally, after being installed in a data processing system, devices are configured during a configuration stage so as to perform specific functions and/or workloads for the data processing system. For some hardware units, such as some programmable embedded logic devices, firmware updates can be performed after configuration, for example to fix a bug; however, the function of such a hardware unit is predetermined by its initial configuration. Some devices, such as FPGAs, comprise configurable logic blocks that allow such devices to be programmable and reconfigurable after manufacturing; however, configuration or reconfiguration of a device can only be performed during a defined reconfigurable time.

There is, therefore, scope to improve the configurable capability of a processing device in a data processing system.

### BRIEF DESCRIPTION OF THE DRAWINGS

Embodiments will now be described, with reference to the accompanying drawings, in which:

FIG. 1 shows an exemplary data processing system according to an embodiment;

FIG. 2 shows an implementation example to illustrate an exemplary configuration of plural modular processing tiles;

FIG. 3 shows the implementation example of FIG. 2 illustrating dynamic reconfiguration of the plural modular processing tiles;

FIG. 4 shows an exemplary cortical column arrangement of plural modular processing tiles; and

FIG. 5 shows a simulator implementation of the present technology.

### DETAILED DESCRIPTION

In view of the foregoing, an aspect of the present technology provides a data processing system comprising: at least one modular processing tile comprising runtime-configurable processing circuitry; and a control module to control the at least one modular processing tile, the control module comprising: instruction decoding circuitry to decode instructions; information collecting circuitry to collect information relating to the at least one modular processing tile; and instruction processing circuitry to process instructions decoded by the instruction decoding circuitry, wherein, in response to an instruction to perform a processing task decoded by the instruction decoding circuitry, the instruction processing circuitry of the control module is configured to a generate a configuration instruction based on the collected information relating to the at least one modular processing tile, and the runtime-configurable processing circuitry of the at least one modular processing tile is configured at runtime to perform the processing task in response to the configuration instruction.

Another aspect of the present technology provides a modular processing tile in a data processing system comprising a control module to control the modular processing tile, the modular processing tile comprising processing circuitry configurable at runtime to perform a processing task in response to configuration instruction received from the control module.

A further aspect of the present technology provides a control module in a data processing system, the control module being configured to control at least one modular processing tile comprising runtime-configurable processing circuitry, the control module comprising: instruction decoding circuitry to decode instructions; information collecting circuitry to collect information relating to the at least one modular processing tile; and instruction processing circuitry to process instructions decoded by the instruction decoding circuitry, wherein, in response to an instruction to perform a processing task decoded by the instruction decoding circuitry, the instruction processing circuitry of the control module is configured to generate configuration instruction based on the collected information relating to the at least one modular processing tile, the configuration instruction causes the runtime-configurable processing circuitry of the at least one modular processing tile to be configured to perform the processing task.

A yet further aspect of the present technology provides a computer program comprising instructions for controlling a host data processing apparatus to provide an instruction execution environment to perform a processing task, the instruction execution environment comprising: modular processing program logic configurable at runtime; instruction decoding program logic to decode instructions; information collecting program logic to collect information relating to the modular processing program logic; and instruction processing program logic to process instructions decoded by the instruction decoding program logic, wherein, in response to an instruction to perform a processing task decoded by the instruction decoding program logic, the instruction processing program logic is configured to generate a configuration instruction based on the collected information relating to the modular processing program logic, and the modular processing program logic is configured at runtime to perform the processing task in response to the configuration instruction.

According to embodiments of the present technology, a data processing system is formed of at least one modular processing tile or unit having configurable processing circuitry controlled by a control module (an orchestrator). The control module is configured to collect information relating to the modular processing tile, e.g. a current or expected workload, and upon receiving an instruction to perform a processing task, the control module decodes the instruction and generate a configuration instruction for the modular processing tile. The control module may be implemented as a software or a hardware unit, or a combination of both. In response to the configuration instruction, the configurable processing circuit of the modular processing tile is functionally configured at runtime such that it is able to perform the processing task. In doing so, the data processing system is capable of performing a range of functions and tasks through the at least one runtime-configurable modular processing tile, without the need to have different dedicated functional units each configured to perform a specific function.

The information relating to the at least one modular processing tile may include any information concerning the modular processing tile that may assist in the determination of whether the modular processing tile is capable of or suitable for performing the processing task, and may include physical parameters, manufacturer setting, etc. In some embodiments, the information relating to the at least one modular processing tile may comprise tile telemetry of the modular processing tile.

In some embodiments, the tile telemetry may comprise performance statistics of the modular processing tile, and the performance statistics may comprise power availability, memory availability, processing capacity, processing speed, or any combination thereof.

In some embodiments, the at least one modular processing tile may comprise local storage to store one or more past configurations of the runtime-configurable processing circuitry, and the information relating to the at least one modular processing tile may comprise the one or more past configurations.

In some embodiments, the control module may be configured to access storage having stored thereon a library of learned functions and configurations of one or more modular processing tiles, and the information relating to the at least one modular processing tile may comprise the library. Through storing and accessing a library of learned functions and configurations, it is possible for the control module to improve the speed of determining which one or more processing tiles to select to perform a particular function and its/their configuration for better performance.

Over time, the control module may be required to configure one or more modular processing tiles in new configurations to perform new functions, and/or the control module may find new ways of configuring one or more modular processing tiles that improve performance. Thus, in some embodiments, the library may be updated based on past performance of one or more modular processing tiles.

In some embodiments, the data processing system may comprise a plurality of modular processing tiles arranged to communicate with the control module over a communication network, the information collecting circuitry may be configured to collect information relating to the plurality of modular processing tiles, and the instruction processing circuitry may be configured to generate the configuration instruction for at least a portion of the plurality of modular processing tiles based on information relating to the at least a portion of the plurality of modular processing tiles, and the at least a portion of the plurality of modular processing tiles may be configured into an interconnected network to perform the processing task in response to the configuration instruction. The use of a plurality of configurable modular processing tiles provides scalability to the data processing system, in that multiple processing tiles may be arranged into an interconnected network dedicated to a specific processing task to improve processing speed and/or capacity, or each processing tile or group of processing tiles may be configured to perform different functions as and when required for improved resource usage.

In some embodiments, the at least a portion of the plurality of modular processing tiles forming the interconnected network may be configured into one or more cortical columns in response to the configuration instruction.

The modular processing tiles of the interconnected network may be arranged in any suitable manner. In some embodiments, the at least a portion of the plurality of modular processing tiles forming the interconnected network may be configured to aggregate into a cascade in response to the configuration instruction, such that one or more modular processing tiles of the interconnected network output directly to one or more other modular processing tiles of the interconnected network. Doing so negates the need for storage that would otherwise be required for storing the output of one or more modular processing tiles for use as input for one or more other modular processing tiles. Overall performance is also improved by reducing the number or read/write operations.

In some embodiments, the information collecting circuitry may be configured to collect information relating to the communication network, and the instruction processing circuitry may be configured to generate the configuration instruction further based on the collected information relating to the communication network.

The information relating to the communication network may include any information concerning the communication network that may affect the configuration of the interconnected network of modular processing tiles and assignment of the processing task, for example it may include any cost or usage policies of communication network. In some embodiments, the information relating to the communication network comprises network telemetry.

In some embodiments, the network telemetry may comprise bandwidth availability, network latency, network congestion, queue utilization, planned tasks, or any combination thereof.

In some embodiments, the instruction processing circuitry may be configured to generate the configuration instruction further based on statistics on past task executions, one or more workload sub-classes, one or more hardware sub-classes, one or more cost models, one or more service priorities, one or more task priorities, a content resolution or a range of content resolution, or any combination thereof.

In some embodiments, the instruction processing circuitry of the control module may be configured to generate the configuration instruction to select the at least a portion of the plurality of modular processing tiles from the plurality of modular processing tile to arrange the interconnected network based on a current workload of each of the at least a portion of the plurality of modular processing tiles. For example, the control module may select modular processing tiles with lower (e.g. lower than a predetermined threshold) or the lowest current workload to form the interconnected network to perform the processing task, and/or actively exclude modular processing tile(s) with higher (e.g. higher than a predetermined threshold) or the highest current workload from the interconnected network.

In some embodiments, the control module and the at least one modular processing tile are local to a single processing resource.

In some embodiments, the system may comprise a plurality of the processing resources and a global control module communicating with the plurality of processing resources over a communication network, the global control module may be configured to centrally control the at least one modular processing tile of each processing resource through the control module of each processing resource.

In some embodiments, the plurality of modular processing tiles may be distributed across more than one processing resource, and the control module may be configured to centrally control the plurality of modular processing tiles over the communication network.

In some embodiments, the control module may be configured to access cloud processing resource through the communication network, and the instruction processing circuitry may be configured to arbitrate the processing task between the cloud processing resource and the at least a portion of the plurality of modular processing tiles forming the interconnected network based on one or more parameters.

In some embodiments, the one or more parameters may comprise power resource available to the at least a portion of the plurality of modular processing tiles forming the interconnected network, latency tolerance of the processing task, bandwidth availability of the communication network, network latency of the communication network, network congestion of the communication network, or any combination thereof.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

Embodiments of the present technology provides configuration points/nodes, or modular processing units/tiles (programmable compute delivery node, implemented as hardware units or simulated by program logic) that are modular and therefore scalable, and are capable of being arranged in an interconnected network controlled by an orchestrator, or control module (implemented as a software, such as a machine learning algorithm MLA, a hardware unit, or a combination of both), arranged to configure the modular processing tiles during runtime. Such a modular processing tile according to the embodiments comprises configurable processing circuitry to enable its function to be configurable during runtime by the control module.

The control module (or orchestrator) is configured to collect real-time inputs from a plurality of modular processing tiles and a communication network to which the control module and the plurality of modular processing tiles are connected, such as tile telemetry concerning the status of the modular processing tiles and network telemetry concerning the status of the communication network. Then, using current telemetry and past statistics, the control module arranges, rearranges, and/or configures one or more modular processing tiles for performing one or more processing tasks, based for example of the current workload of individual or groups of modular processing tiles, the current or expected traffic and/or latency of the communication network, and/or one or more policies concerning individual or groups of modular processing tiles and/or the communication network. Further, a modular processing tile may use one or more of the real-time inputs to optimize its own function. Some examples of such real-time input include:
end-to-end network and data fabric telemetry, including network statistics such as bandwidth, latency, congestion, etc.;
hardware rack/board network telemetry such as an amount of data flow in and/or out of each board and each rack of boards;
on-chip telemetry of individual processing tiles, including power and memory consumption;
performance statistics of past task executions such as a number of cycles taken for execution, a number of cycles taken waiting for information I/O, etc.;
workload sub-classes such as AI, coding/encoding, ray tracing, ray marching, etc.;
hardware sub-classes such as CPU, GPU, NPU (neural processing unit), XPU (any compute architecture), ISP (internet service provider), etc.;
service classes such as control plane, cyber security, etc.;
cost model, including monetary cost as well as network and computing resource costs, such as information I/O that can incur bandwidth and storage cost;
content resolution based on a current task, e.g. HD (high definition), 4K, 8K, frame rate, etc.;
service and task priorities such as best-effort delivery, round-robin scheduling, latency and jitter in relation to task execution, etc.

The control module may further draw resources from a library (or multiple shared libraries) of learned functions, schemes and configurations collected from executions of past processing tasks. The library may be updated in view of performance and/or policy changes. Moreover, the modular processing unit may be configured with caching capabilities to locally store one or more configurations.

In some embodiments, the control module may simply select and configure a single modular processing tile to perform a specific function for a processing task. In other embodiments, multiple modular processing tiles may be configured and functionally combined by the control module into an interconnected network for performing a specific function or for providing a specific service (e.g. data filtering, resolution management, etc.) based on a processing task. Thus, in response to an instruction to perform a processing task, the control module may select and arrange a plurality of modular processing tiles into an interconnected network according to the current workload of individual tiles, tile telemetry collected from individual tiles, network telemetry collected from the communication network, and/or any relevant past statistics, etc. In particular, according to some embodiments, the control module may arrange the interconnected network of modular processing tiles in a form similar to a cortical column found e.g. in a human cerebral cortex, in that the modular processing tiles in the interconnected network are aggregated in a cascade such that an output of one or more modular processing tiles is fed directly as an input of another one or more modular processing tiles. Arranging the modular processing tiles as such reduces or altogether negates the need for memory accesses and the associated storage requirement in relation to storing output data and loading input data.

Architecturally, individual processing resources such as graphics processing units GPUs and neural processing units NPUs may each be provided with one or more modular processing tiles and a local control module for controlling the local modular processing tile(s). Each modular processing tile is configurable, during runtime or otherwise, by the local control module into a dedicated functional unit (e.g. an arithmetic unit) to perform a processing task for the processing resource. In other examples, multiple modular processing tiles may be arranged and functionally combined into an interconnected network by the local control module to perform the processing task for the processing resource. In further examples, a global control module may be implemented in a data processing system comprising a plurality of processing resources having one or more modular processing tiles to oversee local control modules in the plurality of processing resources and one or more system-level modular processing tiles (not belonging to specific processing resources). The global control module may similarly configure, arrange and functionally combine multiple modular processing tiles (individually or via local control modules associated with the modular processing tiles) into an interconnected network at runtime in accordance with the required processing task.

In an implementation example of a data processing system according to the embodiments, a control module configures and arranges a plurality of modular processing tiles into a network of interconnected tiles to perform rendering tasks e.g. to support network gaming. In the present example, the data processing system is connected and have access to cloud computing resources through a communication network, and the control module is configured to arbitrate and distribute processing tasks between the cloud and locally to one or more modular processing tiles. In particular, the control module may select between sending one or more rendering tasks to the cloud or configuring one or more modular processing tiles e.g. into a network to perform the rendering tasks, based for example on network resources availability such as bandwidth, latency, congestion, as well as power consumption in relation to the processing tasks against local power resource availability at the data processing system and/or individual modular processing tiles. Moreover, the control module may optimize or otherwise improve workload sharing between cloud resources and local modular processing tiles by distributing rendering tasks based on latency tolerance for various rendering tasks. For example, rendering tasks less affected by latency (or latency is more acceptable), such as background rendering, may be assigned to cloud resources, while rendering tasks that are more affected by latency (or latency is less acceptable), such as rendering of moving foreground, may be assigned to local processing resources.

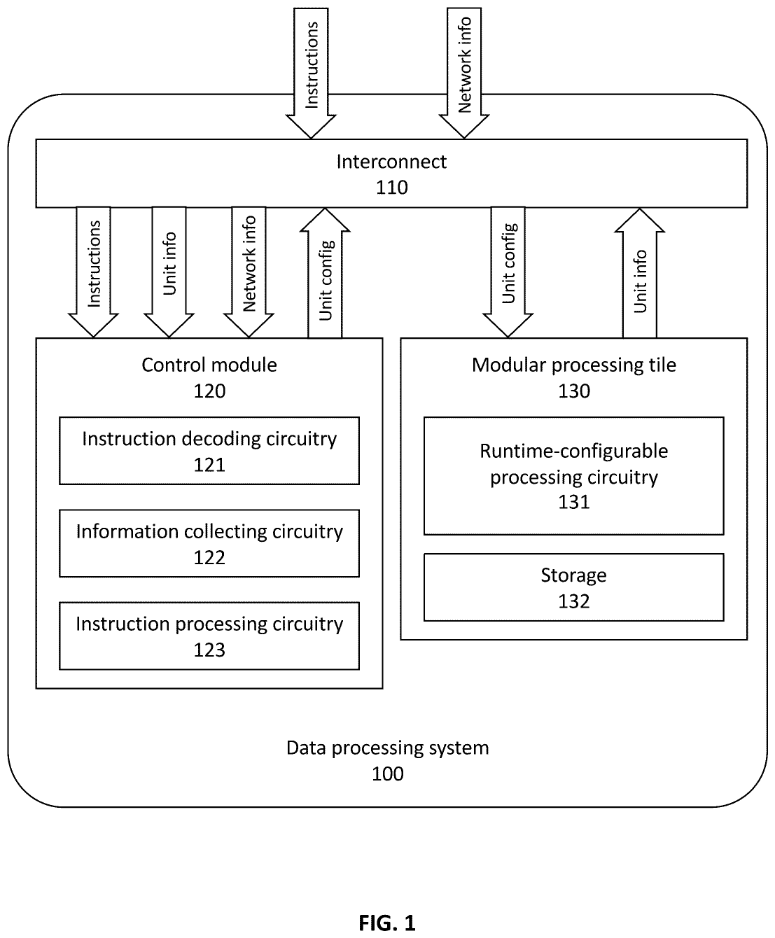

FIG. 1 shows an exemplary data processing system 100 according to an embodiment. The data processing system 100 comprises interconnect 110 for communicating, for example, with a host processor (e.g. a central processing unit CPU) and/or with the cloud. The data processing system 100 further comprises at least one modular processing unit/tile 130 and a control module 120 for controlling the modular processing tile 130, both the control module 120 and the modular processing tile 130 are connected to and communicate through the interconnect 110.

In the present embodiment, the control module 120 comprises instruction decoding circuitry 121 for decoding instructions e.g. received from the host processor, information collecting circuitry 122 for collecting information relating to the modular processing tile 130, and instruction processing circuitry 123 for processing instructions decoded by the instruction decoding circuitry 121. The modular processing tile 130 comprises runtime-configurable processing circuitry 131 that can be configured to perform a specific function, and, optionally, storage 132 for storing one or more past configurations or functions, such that past configurations or functions may in some cases be reused to reduce configuration time. In response to an instruction decoded by the instruction decoding circuitry 121 to perform a processing task, the instruction processing circuitry 123 generates a configuration instruction, using the collected information relating to the modular processing tile 130, to configure the modular processing tile 130 to perform a function specific to the processing task. The runtime-configurable processing circuitry 131 is thus configured at runtime to perform the processing task in response to the configuration instruction.

According to the embodiments, the data processing system 100 is capable of performing a range of functions and tasks through the configurable modular processing tile 130, without the need for a large number of different dedicated functional units.

In further embodiments, more than one modular processing tiles 130 may be provided to the data processing system 100 controlled by the control module 120. In some embodiments, plural modular processing tiles may be implemented a single processing resource (e.g. a GPU) or across plural processing resources controlled by respective control modules. A global control module may be implemented to centrally control the plurality of modular processing tiles, e.g. through the associated control modules or directly in the case of system-level modular processing tiles.

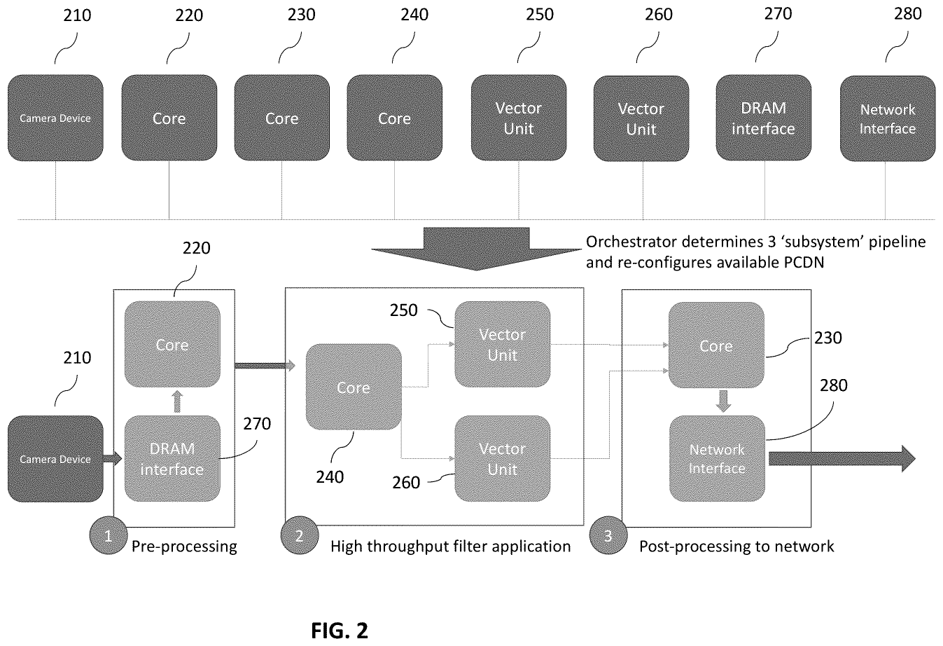

FIG. 2 shows an implementation example to illustrate an example configuration of plural modular processing tiles, such as the modular processing tile 130. The present system comprises a plurality of modular processing tiles 210, 220, 230, 240, 250, 260, 270 and 280. As can be seen in FIG. 2, a modular processing tile may be in various forms, such as a camera device 210, processing cores 220, 230, 240, vector units 250, 260, DRAM interface 270 and network interface 280, amongst many others. According to the embodiments, the plurality of modular processing tiles 210-280 may be configured and arranged such that one or more tiles 210-280 may be functionally combined to perform a desired processing task.

In the present example, a control module (not shown) controlling the modular processing tiles 210-280 determines a pipeline of three subsystem for performing the required processing task, and configures the modular processing tiles 210-280 into the three subsystems of “pre-processing”, “high throughput filter application”, and “post-processing”. In particular, the control module configures the modular processing tiles 210-280 into a network, wherein the output of camera device 210 is used as input to the “pre-processing” subsystem comprising core 220 and DRAM interface 270, the output of which is fed into the “high throughput filter application” subsystem comprising core 240, vector unit 250 and vector unit 260, which in turn feeds its output into the “post-processing” subsystem comprising core 230 and network interface 280. In doing so, the three subsystems of the processing pipeline can be configured during runtime to perform the required processing task(s), and once the required processing task(s) is completed, the modular processing tiles 210-280 forming the pipeline may be released and reconfigured to perform other functions and tasks.

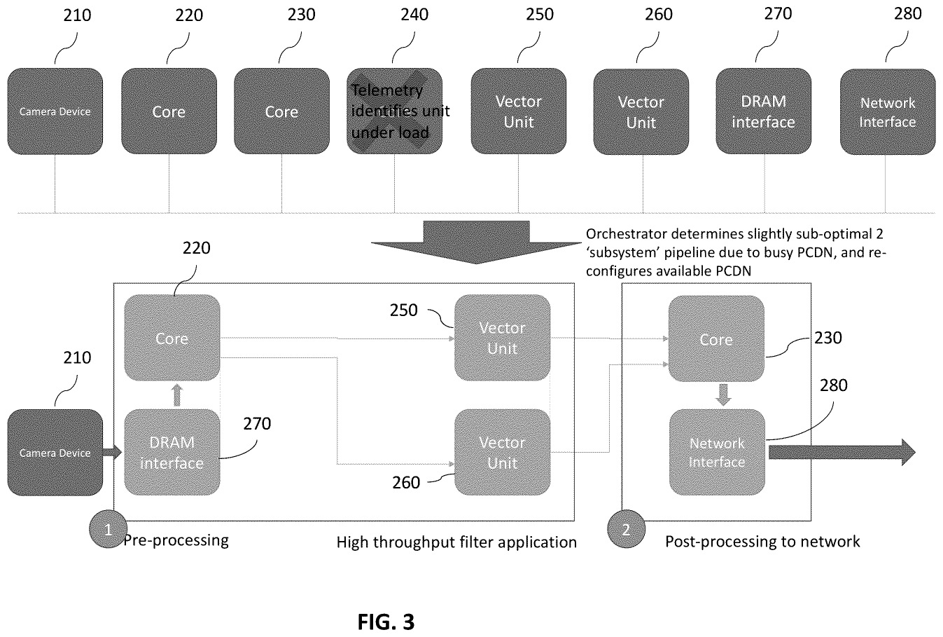

FIG. 3 illustrates the system of modular processing tiles of FIG. 2 being dynamically configured to provide an improved or optimised workflow for a given workload, based on the current system utilisation and state (e.g. tile and network telemetry data).

In the present scenario, core 240 has been identified by the control module (orchestrator), e.g. through tile telemetry received from core 240, as being under load. This may for example be identified by comparing the current workload of core 240 with a predetermined threshold or upper limit, or by core 240 indicating (e.g. using a flag) that it is busy or that it has exceeded or near its workload limit. In this case, the control module excludes the busy core 240 and determines a less optimal processing pipeline with two subsystems. In doing so, the system can still handle the required workload by reconfiguring the processing pipeline.

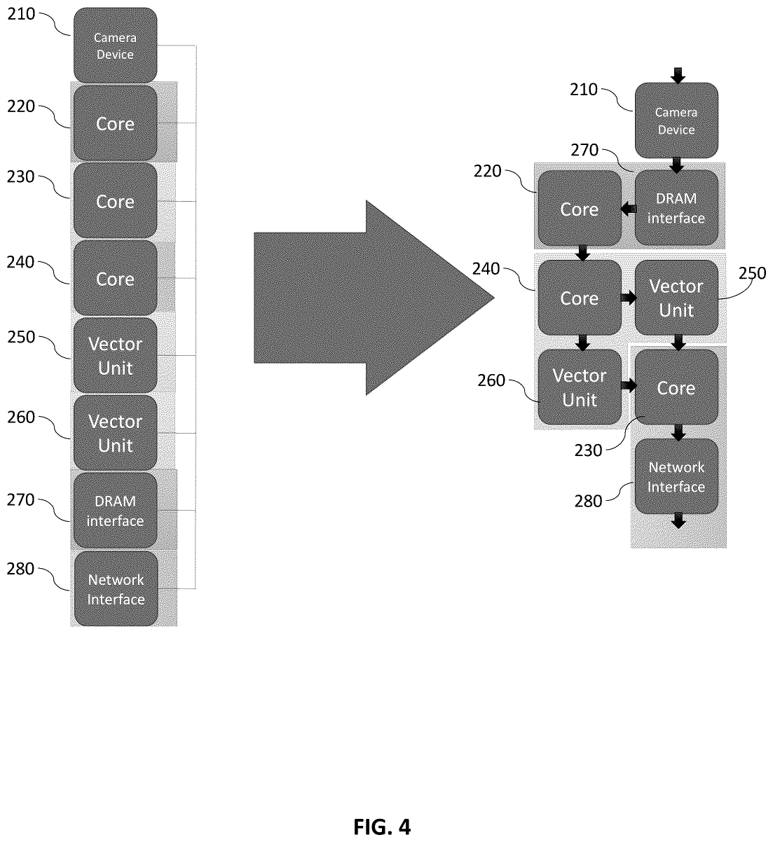

FIG. 4 shows an exemplary configuration of the plurality of modular processing tiles 210-280 arranged in a cortical column arrangement. The black arrows indicate the flow of data within the network of tiles 210-280. As can be seen in FIG. 4, the modular processing tiles 210-280 are aggregated into a cascade such that the output of a tile is fed into another tile as input, e.g. the output of core 220 is directly fed to core 240 as input. In doing so, the need for data storage is reduce or eliminated within the network of tiles, such that resource usage in relation to the workload is reduced, and processing efficiency in relation to the workload is improved by virtue of a reduction in read/write operations.

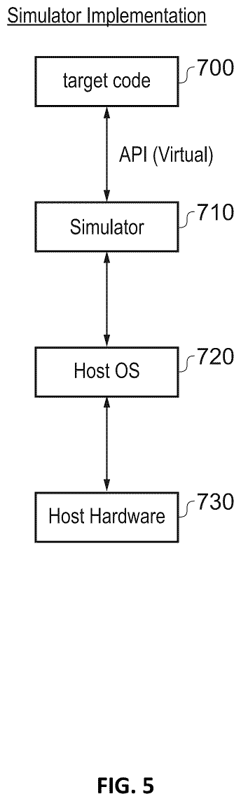

In an alternative embodiment, FIG. 5 illustrates a simulator implementation of the present technology. Whilst the earlier described embodiments implement the present technology in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software-based implementation of a hardware architecture. Varieties of simulator computer programs include emulators, virtual machines, models, and binary translators, including dynamic binary translators. Typically, a simulator implementation may run on a host processor 730, optionally running a host operating system 720, supporting the simulator program 710. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on host hardware (for example, host processor 730), some simulated embodiments may make use of the host hardware, where suitable.

The simulator program 710 may be stored on a computer-readable storage medium (which may be a non-transitory storage medium), and provides a program interface (instruction execution environment) to target code 700 which is the same as the application program interface of the hardware architecture being modelled by the simulator program 710. Thus, the program instructions of the target code 700, such as the runtime configuration method described above, may be executed from within the instruction execution environment using the simulator program 710, so that a host computer 730 which does not actually have the hardware features of the apparatus discussed above can emulate these features.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A data processing system comprising:
at least one modular processing tile comprising runtime-configurable processing circuitry; and
a control module to control the at least one modular processing tile, said control module comprising:
instruction decoding circuitry to decode instructions;
information collecting circuitry to collect information relating to said at least one modular processing tile; and
instruction processing circuitry to process instructions decoded by the instruction decoding circuitry,
wherein, in response to an instruction to perform a processing task decoded by said instruction decoding circuitry, said instruction processing circuitry of said control module is configured to generate a configuration instruction based on the collected information relating to said at least one modular processing tile, and said runtime-configurable processing circuitry of said at least one modular processing tile is configured at runtime to perform said processing task in response to said configuration instruction.

2. The system of claim 1, wherein said information relating to the at least one modular processing tile comprises tile telemetry of said modular processing tile.

3. The system of claim 2, wherein said tile telemetry comprises performance statistics of said modular processing tile, said performance statistics being statistics relating to performance or power status of said modular processing tile, and, optionally, said performance statistics comprises power availability, memory availability, processing capacity, processing speed, processing latency, or any combination thereof.

4. The system of claim 1, wherein said at least one modular processing tile comprises local storage to store one or more past configurations of said runtime-configurable processing circuitry, and said information relating to the at least one modular processing tile comprises said one or more past configurations.

5. The system of claim 1, said control module is configured to access storage having stored thereon a library of learned functions and configurations of one or more modular processing tiles, and said information relating to the at least one modular processing tile comprises said library.

6. The system of claim 5, wherein said library is updated based on past performance of one or more modular processing tiles.

7. The data processing system of claim 1 comprising a plurality of said modular processing tiles arranged to communicate with said control module over a communication network, said information collecting circuitry being configured to collect information relating to said plurality of modular processing tiles, and said instruction processing circuitry being configured to generate said configuration instruction for at least a portion of said plurality of modular processing tiles based on information relating to said at least a portion of said plurality of modular processing tiles, and said at least a portion of said plurality of modular processing tiles is configured into an interconnected network to perform said processing task in response to said configuration instruction.

8. The system of claim 7, wherein said at least a portion of said plurality of modular processing tiles forming said interconnected network is configured into one or more cortical columns in response to said configuration instruction.

9. The system of claim 8, wherein said at least a portion of said plurality of modular processing tiles forming said interconnected network is configured to aggregate into a cascade in response to said configuration instruction, such that one or more modular processing tiles of said interconnected network output directly to one or more other modular processing tiles of said interconnected network.

10. The system of claim 7, wherein said information collecting circuitry is configured to collect information relating to said communication network, and said instruction processing circuitry is configured to generate said configuration instruction further based on the collected information relating to said communication network.

11. The system of claim 10, wherein said information relating to said communication network comprises network telemetry, wherein, optionally, said network telemetry comprises bandwidth availability, network latency, network congestion, queue utilization, planned tasks, or any combination thereof.

12. The system of claim 1, wherein said instruction processing circuitry is configured to generate said configuration instruction further based on statistics on past task executions, one or more workload sub-classes, one or more hardware sub-classes, one or more cost models, one or more service priorities, one or more task priorities, a content resolution or a range of content resolution, or any combination thereof.

13. The system of claim 7, wherein said instruction processing circuitry of said control module is configured to generate said configuration instruction to select said at least a portion of said plurality of modular processing tiles from said plurality of modular processing tile to arrange said interconnected network based on a current workload of each of said at least a portion of said plurality of modular processing tiles.

14. The system of claim 1, wherein said control module and said at least one modular processing tile are local to a single processing resource.

15. The system of claim 14 comprising a plurality of said processing resources and a global control module communicating with said plurality of processing resources over a communication network, said global control module being configured to centrally control said at least one modular processing tile of each processing resource through said control module of each processing resource.

16. The system of claim 7, wherein said plurality of modular processing tiles are distributed across more than one processing resource, and said control module is configured to centrally control said plurality of modular processing tiles over said communication network.

17. The system of claim 16, wherein said control module is configured to access cloud processing resource through said communication network, and said instruction processing circuitry is configured to arbitrate said processing task between said cloud processing resource and said at least a portion of said plurality of modular processing tiles forming said interconnected network based on one or more parameters.

18. The system of claim 17, wherein said one or more parameters comprise power resource available to said at least a portion of said plurality of modular processing tiles forming said interconnected network, latency tolerance of said processing task, bandwidth availability of said communication network, network latency of said communication network, network congestion of said communication network, or any combination thereof.

19. A control module in a data processing system, said control module being configured to control at least one modular processing tile comprising runtime-configurable processing circuitry, said control module comprising:
instruction decoding circuitry to decode instructions;
information collecting circuitry to collect information relating to said at least one modular processing tile; and
instruction processing circuitry to process instructions decoded by the instruction decoding circuitry,
wherein, in response to an instruction to perform a processing task decoded by said instruction decoding circuitry, said instruction processing circuitry of said control module is configured to generate a configuration instruction based on the collected information relating to said at least one modular processing tile, said configuration instruction causes said runtime-configurable processing circuitry of said at least one modular processing tile to be configured to perform said processing task.

20. A computer program comprising instructions for controlling a host data processing apparatus to provide an instruction execution environment to perform a processing task, said instruction execution environment comprising:
modular processing program logic configurable at runtime;
instruction decoding program logic to decode instructions;
information collecting program logic to collect information relating to said modular processing program logic; and
instruction processing program logic to process instructions decoded by the instruction decoding program logic,
wherein, in response to an instruction to perform a processing task decoded by said instruction decoding program logic, said instruction processing program logic is configured to generate a configuration instruction based on the collected information relating to said modular processing program logic, and said modular processing program logic is configured at runtime to perform said processing task in response to said configuration instruction.
